(19) United States
(12) Patent Application Publication
(10) Pub. No.: US 2014/0310112 A1
(43) Pub. Date: Oct. 16, 2014

(54) SYSTEM FOR MONITORING A PRODUCT

(71) Applicant: Elwha LLC, (US)

(72) Inventor: Roderick A. Hyde, Redmond, WA (US)

(21) Appl. No.: 13/863,854

(22) Filed: Apr. 16, 2013

(51) Int. Cl. G06Q 50/12; G06Q 30/00

(52) U.S. Cl. CPC G06Q 50/12; G06Q 30/016
USPC 705/15

(57) ABSTRACT

A product monitoring system for an event venue includes a seat configured to receive a patron, a sensor assembly coupled to the seat and configured to detect the presence of a concession product and to monitor a state of the concession product, and a control module communicatively coupled to the sensor assembly and configured to receive a signal from the sensor assembly and to send a response.

### BACKGROUND

Event venues (e.g. theaters, sports arenas, etc.) typically provide products or concessions (e.g. popcorn, soda, candy, etc.) for sale to patrons before and during an event. However, it can be inconvenient for patrons to purchase the concessions during the event. At movie theaters, for instance, the concessions are most often provided outside of the viewing area, and are thus purchased by patrons before entering the viewing area and before the start of the movie. In order to purchase additional concessions once the movie begins, patrons are forced to exit the viewing area, missing a portion of the movie. At a sporting event, patrons must choose to either miss a portion of the event, or attempt to purchase concessions during breaks from the event when lines can be longer than usual. As a result, event patrons often choose not to purchase additional concessions, leaving event hosts without the benefit of additional concession sales.

In addition, event hosts are typically unable to monitor concessions during the event. For instance, at theaters, event staff typically remain outside of the viewing area once the show has started in order to avoid disrupting the viewing of the show. At sporting events, the seats are often positioned in rows of twenty or more, making it difficult for event staff to monitor the concessions of all patrons. Therefore, event staff may not be aware when a patron wants additional concessions, and the event venue may not receive the benefit of additional concession sales.

### SUMMARY

The foregoing summary is illustrative only and is not intended to be in any way limiting. In addition to the illustrative aspects, embodiments, and features described above, further aspects, embodiments, and features will become apparent by reference to the drawings and the following detailed description.

An embodiment of the present disclosure relates to a product monitoring system for an event venue. The system includes a seat configured to receive a patron, a sensor assembly coupled to the seat and configured to detect the presence of a concession product and to monitor a state of the concession product, and a control module communicatively coupled to the sensor assembly and configured to receive a signal from the sensor assembly and to send a response.

Another embodiment of the present disclosure relates to a product monitoring system for an event venue. The system includes an image sensor assembly configured to detect the presence of a concession product within a patron seating region of the venue, and to monitor a state of the concession product, and a control module configured to receive a signal from the image sensor assembly and to send a response.

Another embodiment of the present disclosure relates to a product monitoring system for an event venue. The system includes a concession product having a state, a radio frequency sensor assembly operably coupled to the concession product and configured to monitor the state of the concession product, and a control module configured to receive a signal from the radio frequency sensor, and to send a response.

Another embodiment of the present disclosure relates to a method for monitoring a concession product at an event venue. The method includes providing a sensor assembly to detect the presence of the concession product and to monitor a state of the concession product, providing a control module communicatively coupled to the sensor assembly, and using the control module to receive signals from the sensor assembly, interpret the signals to determine the state of the concession product, and to send a response.

### BRIEF DESCRIPTION OF THE FIGURES

FIG. 1 is a perspective view of seats for an event venue, according to one embodiment.

FIG. 2 is a close-up perspective view of a seat having an arm rest and cup holder, according to one embodiment.

FIG. 3 is a perspective view of a drink cup, according to one embodiment.

FIG. 4 is a close-up perspective view of a food tray for a theater seat, according to one embodiment.

FIG. 5 is a perspective view of a food container, according to one embodiment.

FIG. 6 is a schematic control diagram of a product monitoring system, according to one embodiment.

FIG. 7 is a perspective view of an arm rest including an electronic response system, according to one embodiment.

FIG. 8 is an illustration of a seating chart for a movie theater, according to one embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

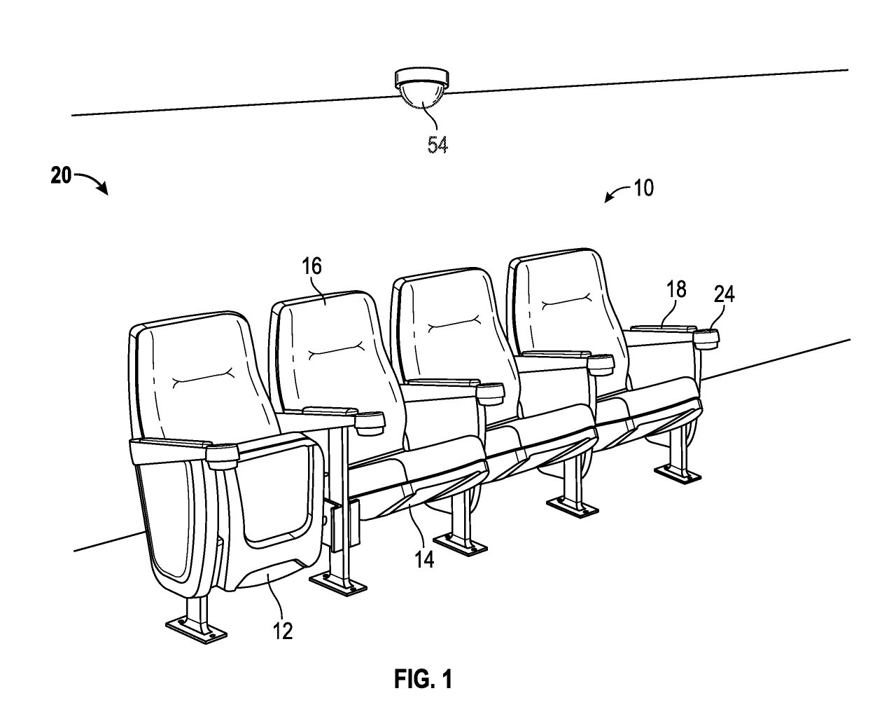

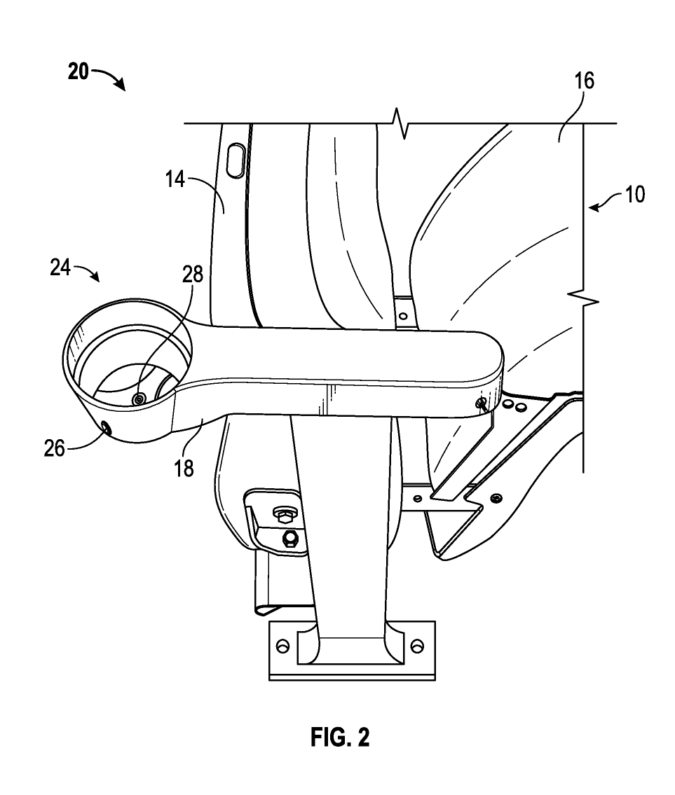

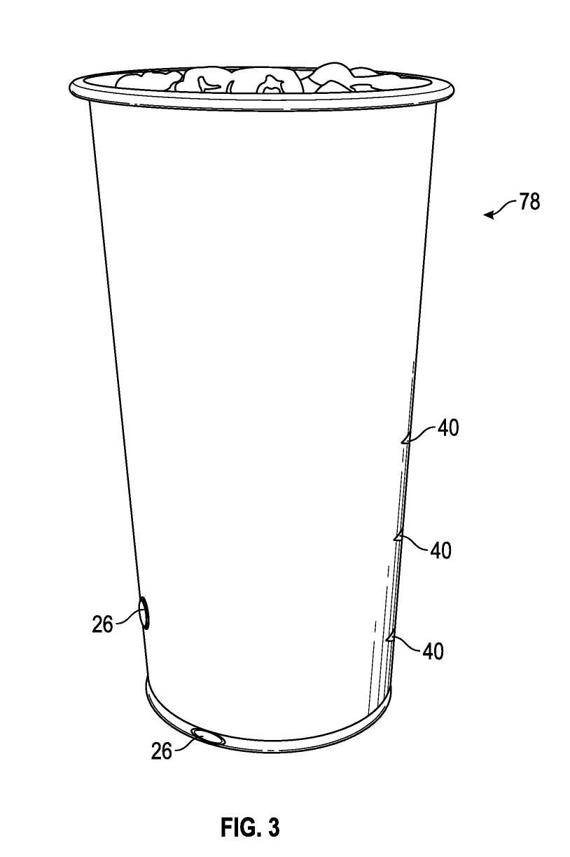

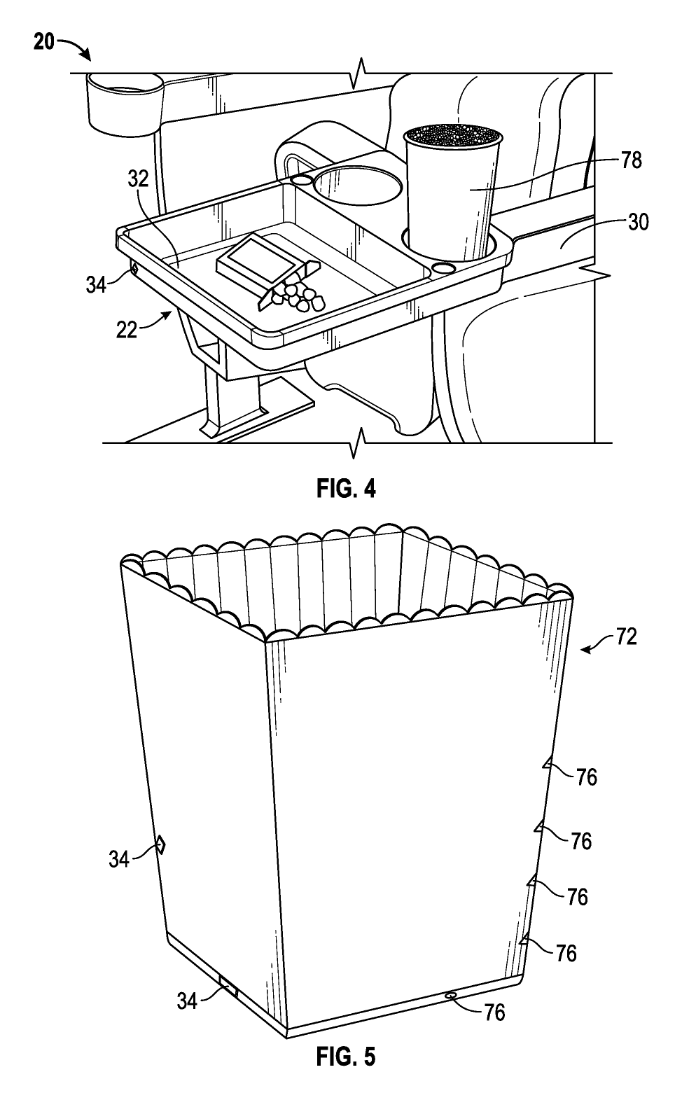

Referring to FIG. 1, a group of seats 10 is shown, according to one embodiment. Seats 10 may be located within a patron seating region of a theater or other venue, providing a place for patrons to sit while viewing an event. Each seat 10 may include a bottom portion 14 and a top portion 16. In the illustrated embodiment of FIG. 1, seats 10 include arm rests 18 on each side of seat 10. Arm rests 18 are shown in a horizontal position, but each arm rest 18 may move between a horizontal position and a vertical position when in use and when not in use, respectively. Each arm rest 18 includes at least one receptacle for holding a product (e.g. concession container, concession product, etc.), shown as cup holder 24 in FIG. 1. Cup holder 24 is sized and configured to receive and hold a concession cup such as drink cup 78 (shown in FIG. 3) that may be purchased at a theater or sporting event. Cup holder 24 may be located at an end of arm rest 18 as in FIG. 1, underneath seat 10, or in another position suitable for the application. In other embodiments, seat 10 may include other types of receptacles, such as food tray 22 shown in FIG. 4. The receptacles may be coupled to arm rest 18 as in FIG. 1, or positioned adjacent to seat 10 so that a patron sitting in seat 10 can access the receptacle. The receptacles may be sized and configured to receive other types of concession containers or concession products, such as containers for candy or popcorn. Arm rest 18 and cup holder 24 are shown in further detail in FIG. 2.

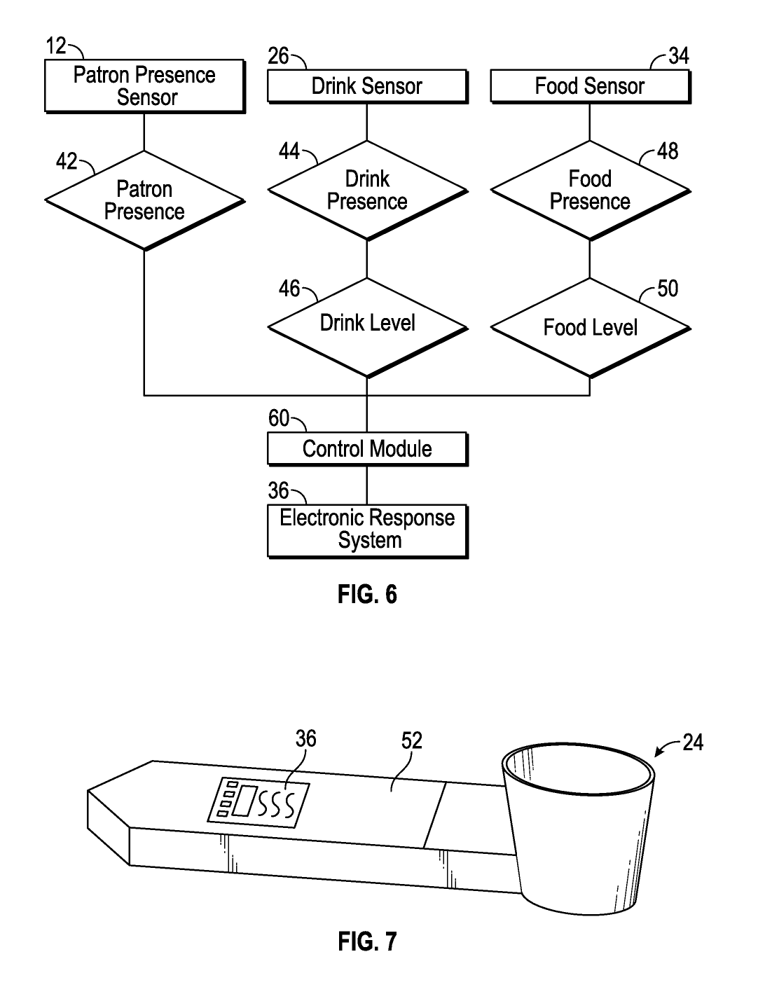

In some embodiments, seat 10 is part of a product monitoring system 20. Product monitoring system 20 may be configured to detect the presence of one or more patrons within seats 10. Product monitoring system 20 may also be configured to monitor the presence of a product (e.g. concessions, souvenirs, etc.) and a state (e.g. fill level, temperature, weight, etc.) of the product. Product monitoring system 20 may be used to monitor concession consumption at event venues, such as movie theaters, sporting venues, convention centers, casinos, or upon transportation (e.g. buses, trains, airplanes, etc.). In some embodiments, product monitoring system 20 includes a sensor assembly having one or more patron presence sensors 12. Patron presence sensors 12 may be coupled to seat 10, coupled to the ceiling or walls of the venue, or in any other position suitable for detecting the presence of patrons in seats 10. Patron presence sensors 12 are “triggered” (i.e. caused to create a signal output) when the presence of a patron is detected. When sensors 12 are triggered, patron presence sensors 12 may send one or more signals 42 to a control module 60 (shown in FIG. 6), indicating the presence of a patron within seats 10.

Patron presence sensors 12 may include one or more types of sensors or presence indicators for detecting the presence of a patron within seat 10. For instance, in some embodiments, patron presence sensors 12 include weight sensors that are triggered when a predetermined weight is reached. In these embodiments, the weight sensors may also send information to control module 60 indicating the weight of the patron. The weight information can be used by control module 60 to help determine a profile for the patron. In other embodiments, patron presence sensors 12 include optical transmitters that emit optical transmissions or light beams that are pointed at seat 10 and triggered when one or more optical transmissions are contacted. Patron presence sensors 12 may also include an image sensor, such as a photo-sensor or camera, pointed at seat 10 and triggered when a patron is detected within seat 10. In still other embodiments, patron presence sensors 12 are coupled or positioned adjacent to arm rest 18, and triggered when arm rest 18 is in the horizontal position, indicating that seat 10 is in use and a patron is present within seat 10. In some embodiments, patron presence sensors 12 are located within bottom portion 14 of seat 10, and are triggered when bottom portion 14 is in the horizontal position, indicating that seat 10 is in use. In other embodiments, patron presence sensors 12 may also include ultrasound sensors, micro-impulse radar sensors, or any other type of sensor configured to detect the presence of a patron within seat 10. In some embodiments, the presence of a patron in a given seat 10 may be inferred by a ticket identification device (not shown). The ticket identification device may be located at or near the seat 10, or it may be located remotely (e.g., at an entrance to the venue, an entrance to a seating area of the venue, carried by a venue employee, carried by the patron, or the like).

In the illustrated embodiment of FIG. 1, product monitoring system 20 includes an image sensor assembly shown as image sensors 54. The image sensors 54 are shown coupled to the ceiling of the venue in FIG. 1, but image sensors 54 may be positioned in any location such that image sensors 54 are able to detect the presence of a patron or a concession product within seat 10. Image sensors 54 may include a photo-sensor or camera, and may be triggered when a patron or concession product is detected within seat 10. The image sensor assembly may include image sensors 54, patron presence sensors 12, or another type of sensor suitable for the particular application. The image sensor assembly is described in further detail below.

Referring now to FIG. 2, arm rest 18 including cup holder 24 is shown, according to one embodiment. In this embodiment, cup holder 24 includes base 28 positioned at the bottom of cup holder 24 and providing a stop for a cup such as drink cup 78. In other embodiments, cup holder 24 may have an open bottom. Product monitoring system 20 may include a receptacle such as cup holder 24.

In some embodiments, product monitoring system 20 includes a sensor assembly having one or more drink sensors 26. Drink sensors 26 are configured to detect the presence of a product at seat 10, such as drink cup 78. In some embodiments, drink sensors 26 are positioned within or adjacent to cup holder 24, or are otherwise coupled to cup holder 24, and are triggered by the presence of a product within cup holder 24. In other embodiments, drink sensors 26 are positioned on the ceiling of the venue, on one or more walls of the venue, or in another location suitable for the application, and are triggered by the presence of a product in the vicinity of seat 10. Drink sensors 26 may be coupled to control module 60, and may be configured to send one or more signals 44 to control module 60 when triggered, indicating the presence of a product such as drink cup 78 in the vicinity of seat 10.

Drink sensors 26 may also be configured to monitor a state of a product. For instance, drink sensors 26 may be configured to detect a temperature of the product, a weight of the product, or another state associated with the product. Drink sensors 26 may also detect when the product is empty, and a drink level (i.e. fractional fullness) of the product. Drink sensors 26 may be configured to send one or more signals 46 to control module 60, indicating the state of the product. In some embodiments, one or more drink sensors 26 are positioned such that one or more states of the product may be monitored.

Drink sensors 26 may include one or more types of sensors or drink level indicators suitable for detecting the presence of a product such as drink cup 78, or a state such as the drink level within drink cup 78. For instance, in some embodiments, drink sensors 26 are weight sensors configured to measure the weight of drink cup 78 and its contents. In these embodiments, drink sensors 26 may be coupled to base 28 of drink cup 78 or in another position suitable for measuring the weight of drink cup 78. In other embodiments, drink sensors 26 are ultrasonic sensors, having an ultrasonic transmitter configured to send an ultrasonic pulse in the direction of drink cup 78, and creating one or more signals 44 and/or 46 representing the reflectivity of the pulse. In some embodiments, the reflection time of the pulse (i.e. the time required for the ultrasonic pulse to be reflected back to the transmitter) can be used to determine the level of drink within a drink cup 78. In some embodiments, the reflection amplitude of the pulse can be used to determine the presence and/or amount of drink in the drink cup 78. In some other embodiments, drink sensors 26 include optical transmitters that send one or more optical transmissions or light beams across one or more paths near base 28 of drink cup 78. In these embodiments, sensors 26 create one or more signals 44 and/or 46 representing the refraction or absorption of the transmissions or light beams in order to detect the presence of drink cup 78 and to measure the drink level within drink cup 78. In some embodiments, drink sensors 26 are image sensors (e.g. photo-sensor, camera, etc.) configured to detect the presence of drink cup 78 and/or the drink level within drink cup 78. In some embodiments, drink sensors 26 are electrical resistivity sensors configured to measure the electrical resistivity of drink cup 78 and its contents. In these embodiments, a change in electrical resistance measured by sensors 26 may indicate a change in drink level. Further in these embodiments, drink cup 78 may include a conductive ink permeating the cup material, increasing the conductivity of drink cup 78 and enhancing the difference in electrical resistance caused by a change in drink level. In some embodiments, drink cup 78 comprises two or more parallel conductors (i.e., printed via conductive ink) along the length of the drink cup 78 and conductively linked by the presence of drink within drink cup 78. In these embodiments, the resistance between the parallel conductors can be used to determine the level of liquid within drink cup 78. In some embodiments, drink sensors 26 are capacitive sensors incorporated within drink cup 78 or within cup holder 24. In some other embodiments, drink sensors 26 are micro-impulse radar sensors (i.e. low-power ultra wideband radar used for sensing and measuring distances to objects in proximity to each other).

Referring now to FIG. 3, drink cup 78 (e.g. product container) is shown, according to one embodiment. In some embodiments, drink sensors 26 are coupled to drink cup 78 and configured to communicate with control module 60 (shown in FIG. 6) wirelessly (alternatively, the communication can occur via wires, optical fibers, or other communication channels). Drink sensors 26 may extend along the side of drink cup 78, along the bottom of drink cup 78, or in another position on or within drink cup 78 that is suitable for monitoring the drink level within drink cup 78.

In one embodiment, product monitoring system 20 includes a radio frequency (RF) assembly. In this embodiment, the RF assembly includes drink cup 78 having passive RF (radio frequency) antennas 40 that are discretely positioned at different height levels along the side of drink cup 78 in order to monitor the drink level within drink cup 78. RF antennas 40 may also include RFID tags and may be configured to send one or more signals to control module 60 via radio frequency. The RFID tag may be coupled to a sensor (e.g. drink sensor 26) configured to monitor a state (e.g. drink level) of a product concession (e.g. drink cup 78). In these embodiments, RF antennas 40 may be coupled to one or more drink sensors 26 to determine the drink level within drink cup 78 based on weight, ultrasonic pulses, electrical conductivity, or another factor suitable for the application. RF antennas 40 may be configured to send a signal to control module 60 when the state of the product concession reaches a predetermined threshold. The RFID tag may be attached to the product container, and the RFID tag may be coupled to a sensor configured to monitor the state of the product.

In one embodiment, a scattering response of passive RF frequency antenna 40 is configured to change in response to contact with the product concession. An RF transmitter may be configured to transmit RF energy to passive RF antenna 40, and a second RF antenna may be configured to receive RF energy scattered form passive RF antenna 40.

Referring now to FIG. 4, arm rest 30 including food tray 22 is shown, according to one embodiment. In this embodiment, food tray 22 includes surface 32 for holding one or more products, such as food container 72 (shown in FIG. 5). In other embodiments, food tray 22 may include one or more sections sized and configured to hold specific products or concessions. In the illustrated embodiment of FIG. 4, food tray 22 is sized and configured to receive one or more food containers holding concessions such as popcorn, hot dogs, or candy. Product monitoring system 20 may include a receptacle such as food tray 22 coupled to seat 10.

In some embodiments, product monitoring system 20 includes a sensor assembly having one or more food sensors 34. Food sensors 34 are configured to detect the presence of a product at seat 10, such as food container 72. In some embodiments, food sensors 34 are positioned within or adjacent to food tray 22, or are otherwise coupled to food tray 22, and are triggered by the presence of a product within food tray 22. In other embodiments, food sensors 34 are positioned on the ceiling of the venue, on one or more walls of the venue, or in another location suitable for the application, and are triggered by the presence of a product in the vicinity of seat 10. Food sensors 34 may be coupled to control module 60, and may be configured to send one or more signals 48 to control module 60 when triggered, indicating the presence of a product such as food container 72 in the vicinity of seat 10.

Food sensors 34 may also be configured to monitor a state of a product. For instance, food sensors 34 may detect the temperature of the product, the weight of the product, or another state associated with the product. Food sensors 34 may also detect when the product is empty, and a food level (i.e. fractional fullness) of the product. Food sensors 34 may be configured to send one or more signals 50 to control module 60, indicating the state of the product. In some embodiments, one or more food sensors 34 are positioned such that one or more states of the product may be monitored.

Food sensors 34 may include one or more types of sensors or food level indicators suitable for detecting the presence of a product such as food container 72, or a state such as the food level within food container 72. For instance, in some embodiments, food sensors 34 are weight sensors configured to measure the weight of food container 72 and its contents. In these embodiments, food sensors 34 may be coupled to food tray 22 or in another position suitable for measuring the weight of food container 72. In other embodiments, food sensors 34 are ultrasonic sensors, having an ultrasonic transmitter configured to send an ultrasonic pulse in the direction of food container 72, and creating one or more signals 48 and/or 50 representing the reflectivity of the pulse. The reflection time of the pulse (i.e. the time required for the ultrasonic pulse to be reflected back to the transmitter) may be used to determine the level of popcorn within food container 72. In some embodiments, the reflection amplitude of the pulse may be used to determine the presence and/or amount of food product in food container 72. In some embodiments, food sensors 34 include optical transmitters that send one or more optical transmissions or light beams across one or more paths within food container 72. In these embodiments, food sensors 34 create one or more signals 48 and/or 50 representing the refraction or absorption of the transmissions or light beams in order to detect the presence of food container 72 and to measure the food level within food container 72. In some embodiments, food sensors 34 are image sensors (e.g. photo-sensor, camera, etc.) configured to detect the presence of food container 72 and/or the food level within food container 72. In some embodiments, food sensors 34 are RF sensors configured to determine the food level within food container 72. In some other embodiments, food sensors 34 are micro-impulse radar sensors. Food sensors 34 may also determine the food level based on weight, ultrasonic pulses, electrical conductivity, or another type of sensor suitable for the application.

Referring now to FIG. 5, food container 72 (e.g. product container) is shown, according to one embodiment. In some embodiments, product monitoring system 20 may include a radio frequency (RF) assembly. In these embodiments, food sensors 34 may be coupled to food container 72 and configured to communicate with control module 60 wirelessly by radio frequency. The RF assembly may include one or more RF transmitters configured to transmit radio frequency energy to one or more passive RF antennas. In the illustrated embodiment of FIG. 5, food container 72 is an RF responsive container including one or more passive RF antennas 76. RF antennas 76 receive a signal from RF transmitters that is shorted out, or dampened, by the presence of food within food container 72. RF antennas 76 may also include a scattering response that is configured to change in response to contact with the concession product. In the illustrated embodiment of FIG. 5, when popcorn is consumed from food container 72, and the food level within food container 72 approaches a predetermined threshold (i.e. product limit at which a response is sent), a signal is transmitted to control module 60 indicating the food level within food container 72. RF antennas 76 may extend along the sides of food container 72, or can be positioned along the bottom of food container 72. RF antennas 76 may be positioned discretely at different height levels along the sides of food container 72 in order to determine the food level within food container 72. In some embodiments, product monitoring system 20 includes RF antennas 76 within food container 72, and also includes one or more food sensors 34. Food container 72 may include food sensors 34 or RF antennas 76 that send one or more signals to control module 60 via radio frequency.

In one embodiment, product monitoring system 20 includes an image sensor assembly having one or more image sensors 54 (e.g. photo sensor, camera, etc.) (shown in FIG. 1). In this embodiment, image sensors 54 are configured to detect the presence of drink cup 78 and/or a food container such as food container 72. Image sensors 54 may also be configured to monitor the drink level and/or food level of drink cup 78 and/or food container 72, respectively. Image sensors 54 send signals to the control module 60 to indicate presence of a patron, drink cup 78, food container 72, and/or drink levels and/or food levels within drink cup 78 and food container 72, respectively. In some embodiments, image sensors 54 may be coupled to seat 10, positioned on a ceiling (as in FIG. 1), or one or more walls of the event venue, or in another location suitable for the application. In some embodiments, the optical path between image sensors 54 and a patron's drink cup 78 or food container 72 may incorporate one or more optical elements (e.g., mirrors, lenses, diffraction gratings) as part of the image sensor assembly. These may, for instance, be located on a venue ceiling in order to provide a substantially vertical view of a patron's drink cup 78 or food container 72. In some embodiments, image sensors 54 utilize active illumination (i.e. lighting whose direction, intensity, and pattern are controlled by commands or signals). In some embodiments, image sensors 54 detect food and/or drink level by high-quality spatial imaging (i.e. recording spatial information by two or more viewpoints of a camera). In some embodiments, (for instance, in order to avoid disturbing patrons in a darkened venue, and/or to increase signal-to-noise ratios) image sensors 54 may also utilize an infrared or ultraviolet light source, high-sensitivity night vision imagers, and/or short-pulse, time-gated illumination and imaging.

Image sensors 54 may be configured to detect an additive, such as food coloring or dye, in some embodiments. In these embodiments, drink cup 78 and/or food container 72 may include an additive so that the empty portions of drink cup 78 and food container 72 are more visible to image sensors 54. The additive may be fluorescent and/or reflective. The additive is used to coat an inside surface of drink cup 78 or food container 72 such that image sensors 54 are able to more easily detect how much of the inside surface is exposed. The additive may be on the bottom of the drink cup 78 or food container 72 and/or on the sides of the drink cup 78 or food container 72. The additive may be spatially or spectrally patterned to increase the visibility of the inside surface of drink cup 78 or food container 72. The concessions (i.e. food and drink) may also include an FDA-approved additive that allows image sensors 54 to more easily detect the presence and/or amount of concessions in a dark environment, such as a movie theater. In these embodiments, product monitoring system 20 may include one or more light sources (e.g. lights) coupled to the ceiling and configured to illuminate the additive so that image sensors 54 may more easily detect the presence and/or amount of concessions.

Referring now to FIG. 6, a schematic control diagram for product monitoring system 20 is shown, according to one embodiment. In this embodiment, patron presence sensors 12 send one or more patron presence signals 42 to control module 60, representing whether a patron is present within a particular seat, such as seat 10. Drink sensors 26 send one or more drink presence signals 44 and one or more drink level signals 46 to control module 60, representing whether a cup such as drink cup 78 is present within an area of a particular seat and the drink level within drink cup 78 at that seat, respectively. Food sensors 34 send one or more food presence signals 48 and one or more food level signals 50 to control module 60, representing whether a food container is present within an area of a particular seat and the food level within the food container at that seat, respectively.

In some embodiments, control module 60 interprets signals 42, 44, 46, 48, and 50, and may create one or more responses based on signals 42, 44, 46, 48, and 50. Control module 60 may be configured to receive a plurality of signals 42, 44, 46, 48, and 50 from a plurality of sensor assemblies coupled to a plurality of seats 10. Signals 42, 44, 46, 48, and 50 may be received from a plurality of concession products, and control module 60 may base its response on signals 42, 44, 46, 48, and 50. In one embodiment, if a patron is not present within seat 10, control module 60 does not send a response to seat 10 or to the patron within seat 10. Control module 60 continuously receives patron presence signals 42, monitoring seat 10 until a patron occupies seat 10. If a patron is present within seat 10, control module 60 determines whether there is a drink cup or a food container at or near seat 10 by receiving and interpreting drink presence signal 44 and food presence signal 48. If a drink cup or food container is present, control module 60 receives and interprets drink level signals 46 and food level signals 50 in order to monitor the drink level and food level, respectively. In some embodiments, control module 60 determines whether the drink level has reached a predetermined drink level threshold (i.e. the drink cup 78 is below a desired drink level), and whether the food level has reached a predetermined food level threshold (i.e. the food container 72 is below a desired food level). In some embodiments, the sensor assembly (e.g. drink sensors 26, food sensors 34, etc.) sends a signal to the control module 60 when the state of the product reaches the predetermined drink level and/or food level threshold. Control module 60 may send a query to the sensor assembly (e.g. drink sensors 26, food sensors 34, patron presence sensors 12, etc.) requesting that it deliver a signal regarding the status of a patron's product. The sensor assembly may respond by sending previously determined information, or may undertake a new measurement and send that information. Control module 60 may additionally send operational instructions to the sensor assembly, such as reporting schedules, level thresholds, and the like.

If the drink or food levels drop below the drink or food level thresholds, respectively, control module 60 is configured to send a response to a communication device. The communication device is intended to provide the patron with concession offers and/or opportunities to purchase concessions. The communication device is shown in FIGS. 6 and 7 as electronic response system 36. Control module 60 may also provide one or more responses as the food and/or drink levels approach zero, and may provide one or more responses when the food and/or drink levels reach zero. The responses may include offers for discounted concessions, extra concessions, priority concession services, or other responses suitable for the application.

Control module 60 can also be configured to control other functions of the communication device. In some embodiments, control module 60 includes a processor and memory device. Processor can be implemented as a general purpose processor, an application specific integrated circuit (ASIC), one or more field programmable gate arrays (FPGAs), a group of processing components, or other suitable electronic processing components. Memory device (e.g., memory, memory unit, storage device, etc.) is one or more devices (e.g., RAM, ROM, flash memory, hard disk storage, etc.) for storing data and/or computer code for completing or facilitating the various processes, layers and modules described in the present application. Memory device may be or include volatile memory or non-volatile memory. Memory device may include database components, object code components, script components, or any other type of information structure for supporting the various activities and information structures described in the present application. According to one embodiment, memory device is communicably connected to processor via processing circuit and includes computer code for executing (e.g., by processing circuit and/or processor) one or more processes described herein.

Referring now to FIG. 7, electronic response system 36 is shown coupled to arm rest 52, according to one embodiment. In some embodiments, product monitoring system 20 includes a communication device shown as electronic response system 36. Electronic response system 36 is coupled to control module 60. Electronic response system 36 is configured to receive responses from control module 60, and to convey the responses to a patron. Electronic response system 36 may also be configured to receive input from a patron, and to send the input to control module 60.

In the illustrated embodiment of FIG. 7, electronic response system 36 is built into seat 10, but may be otherwise coupled to seat 10 in other embodiments. Control module 60 is configured to provide one or more messages to the patron via electronic response system 36 when the food and/or drink levels have reached the predetermined thresholds, and may provide one or more additional messages at various food and/or drink levels as the levels approach zero. In some embodiments, electronic response system 36 is configured to display one or more alphanumeric messages sent by control module 60. Electronic response system 36 may vibrate when a message is received, or may indicate the presence of a message to the patron in another manner suitable for the application. The messages may include an offer of one or more concessions to the patron. The message may also include a special offer or sale on one or more concessions. Control module 60 may also be configured to send messages making different offers depending upon the food and/or drink levels (e.g. the offer may change as the food and/or drink levels drop). In other embodiments, electronic response system 36 includes one or more lights or other indicators. In these embodiments, electronic response system 36 may be configured to turn the lights on or off, or change the color of the lights, based on a response received from control module 60. The lights are intended to indicate an offer of concessions or some other information related to the concessions purchased by the patron. In some embodiments, electronic response system 36 is configured to receive an input from the patron. In these embodiments, the patron may accept or decline the concession offer via electronic response system 36. Electronic response system 36 may also be configured to accept alphanumeric or other types of messages from the patron, and to send the messages to control module 60.

In some other embodiments, the communication device may include a patron's cellular phone. In these embodiments, control module 60 is configured to send a response in the form of a text message to one or more patrons once the food and/or drink levels have reached the predetermined threshold. The patrons may provide a cellular phone number capable of receiving texts at the time concessions are purchased, or at some other time before or during an event. The patrons may also connect their cellular phone number to a particular assigned seat when purchasing a ticket for an event. When one or more concessions reach the predetermined threshold, control module 60 may be configured to send one or more text messages to the associated patron. A group of patrons may designate a single phone number as a designated purchaser for their entire party. In these embodiments, control module 60 may be configured to send one or more text messages to the designated purchaser once any concession within the party reaches the predetermined threshold. Control module 60 may also send a text message to an adult within a group when the concessions of a child within the group reaches the predetermined threshold. The group may offer this information voluntarily, or control module 60 may determine the designated purchaser based on information collected from sensors 12, 26, and 34. As an alternative, each patron may have the option to assign a cellular phone number to a specific seat, and control module 60 may be configured to send one or more text messages to the phone number associated with that seat once one or more of the concessions associated with that seat reaches the predetermined threshold. The text message may contain an offer for discounted concessions, a notification identifying the concessions available, or any other message suitable for the application. In some embodiments, control module 60 may receive and interpret text messages from one or more patrons, and to respond to the content of the text messages. Control module 60 may be configured to receive text messages from patrons accepting or declining an offer of concessions, ordering one or more concessions, or containing any other content suitable for the application.

Product monitoring system 20 may include other types of communication devices, in other embodiments. Control module 60 may be configured to send responses to these communication devices, and the communication devices may then convey a response to a patron. For instance, product monitoring system 20 may include a seat display (not shown) that is coupled to the back of seat 10 and configured to display messages to one or more patrons based on a response from control module 60. Product monitoring system 20 may also include a headset (not shown) that is worn by the patron and configured to deliver audible or haptic feedback to the patron based on a response from control module 60. Product monitoring system 20 may include a robotic or automated vendor (not shown) configured to deliver messages and/or concessions to the patron based on a response from control module 60. In other embodiments, product monitoring system 20 may include any other types of communication devices, including any device suitable for receiving responses from control module 60 and delivering the responses and/or messages to a patron. In some embodiments, control module 60 may be configured to send responses concerning the state of a patron's products to a venue operator (e.g. venue service provider) and/or to a product provider. The venue operator and/or product provider can perform some or all of the functions discussed herein for control module 60. They can additionally use product information for purposes such as deciding when to restock products, deciding relative usage rates of different products, correlating rates of concession consumption to venue activities (e.g., to scenes of a movie, to ball possession in a sporting event, etc.), to determine efficacy of advertisements or product placements in a movie, to determine the desirability of real-time advertisements or product placements, to correlate product usage with patron demographics, or the like.

Control module 60 may be programmed to calculate a product depletion rate (i.e. concession consumption rate) from signals 46 and 50 received from sensors 26 and 34, respectively. Control module 60 may be further programmed to use the concession consumption rate and the drink and food levels to predict when the predetermined threshold will be reached. Control module 60 may provide a response to electronic response system 36 in anticipation of a threshold being reached based on the consumption rate. Control module 60 may also be configured to send responses to electronic response system 36 at a rate relative and substantially proportional to the concession consumption rate (i.e. to send more responses to the communication device when the consumption rate is high, and to send fewer responses to the communication device when the consumption rate is low). Control module 60 may send responses individually to the communication device for each type of concession, or may provide responses for one or more groups of concessions purchased by a patron or by a group of patrons. Control module 60 may also request (i.e. send a query requesting) product information (e.g. product levels, product presence, product temperature, etc.) from the sensor assembly (e.g. image sensor assembly, RF sensor assembly, etc.). The sensor assembly (e.g. sensors 12, 26, 34, etc.) may then monitor a state of the product in response to the query from control module 60.

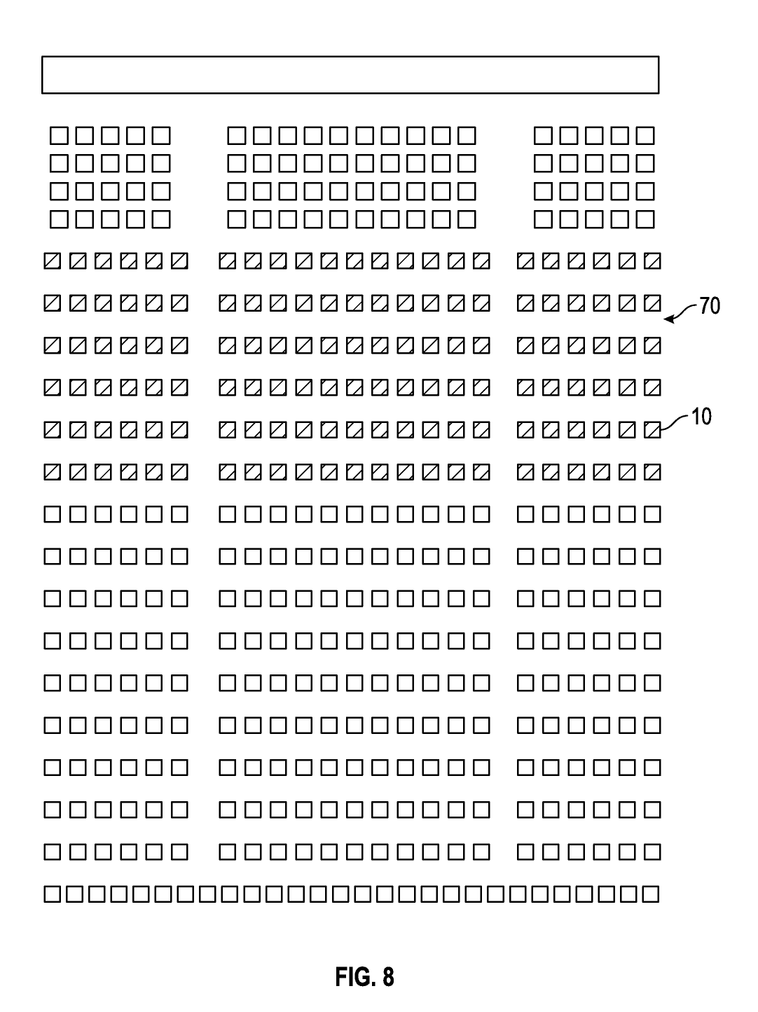

Referring now to FIG. 8, seating chart 70 for an event having concessions is shown, according to one embodiment. In some embodiments, product monitoring system 20 includes seating chart 70 displaying data for seats 10 and patron within the venue. Control module 60 receives data from sensors 12, 26, and 34 and uses the data to populate seating chart 70. Seating chart 70 may display any data collected by sensors 12, 26, and 34, calculated by control module 60, or provided by a patron. The information displayed within seating chart 70 may include whether a patron is present within a particular seat, the amount of drink cups and/or food containers present at the seat, cellular phone information for each patron, group information, certain patron demographics (e.g. approximate age, sex, etc.), and previous concession purchase history. Seating chart 70 can be used by event employees and/or control module 60 to determine the offers and/or concessions to provide to the patrons.

The construction and arrangement of the apparatus, systems and methods as shown in the various embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, some elements shown as integrally formed may be constructed from multiple parts or elements, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the described embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another. Such joining may be communicative, rather than physical.

Although the figures may show or the description may provide a specific order of method steps, the order of the steps may differ from what is depicted. Also two or more steps may be performed concurrently or with partial concurrence. Such variation will depend on various factors, including software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

1. A product monitoring system for an event venue, comprising:
a seat configured to receive a patron;
a sensor assembly coupled to the seat and configured to detect the presence of a concession product and to monitor a state of the concession product; and
a control module communicatively coupled to the sensor assembly and configured to receive a signal from the sensor assembly and to send a response.

2-3. (canceled)

4. The system of claim 1, further comprising:
a communication device configured to receive the response from the control module and to convey the response to the patron.

5. The system of claim 1, wherein the sensor assembly is configured to detect the presence of the patron in the seat.

6. The system of claim 1, wherein the concession product comprises a drink cup, and wherein the sensor assembly is configured to detect the presence of the drink cup.

7. The system of claim 6, wherein the state comprises a drink level of the drink cup, and wherein the sensor assembly is configured to monitor the drink level.

8. The system of claim 7, further comprising:
a drink cup holder coupled to the seat and configured to receive the drink cup; and
wherein the sensor assembly is coupled to the drink cup holder.

9-16. (canceled)

17. The system of claim 7, wherein the sensor assembly comprises an image sensor.

18. (canceled)

19. The system of claim 17, wherein the drink cup comprises an additive, and wherein the image sensor is configured to detect the additive.

20-39. (canceled)

40. The system of claim 1, wherein the control module is programmed to calculate a product depletion rate based on the signals received from the sensor assembly.

41. The system of claim 40, wherein the state comprises a product level.

42. (canceled)

43. The system of claim 41, wherein the control module is programmed to estimate the product level based on the product depletion rate.

44. (canceled)

45. The system of claim 4, wherein the control module is configured to send the response to the communication device when the state of the concession product reaches a predetermined threshold.

46. (canceled)

47. The system of claim 45, wherein the response comprises an offer of a product for purchase.

48-54. (canceled)

55. The system of claim 4, wherein the communication device comprises a cellular phone, and the response comprises a text message.

56-59. (canceled)

60. The system of claim 1, wherein the response is delivered to an automated vendor configured to deliver the concession product to the seat.

61. The system of claim 1, further comprising a seating chart configured to display a patron profile for the seat.

62-68. (canceled)

69. The system of claim 1, wherein the control module is configured to receive a plurality of signals from a plurality of seat coupled sensor assemblies, and to base its response on the plurality of signals.

70. (canceled)

71. A product monitoring system for an event venue, the system comprising:
an image sensor assembly configured to detect the presence of a concession product within a patron seating region of the venue, and to monitor a state of the concession product; and
a control module configured to receive a signal from the image sensor assembly and to send a response.

72-73. (canceled)

74. The system of claim 71, further comprising:
a communication device configured to receive the response from the control module and to convey the response to a patron.

75-79. (canceled)

80. The system of claim 71, wherein the concession product comprises an additive, and wherein the image sensor assembly is configured to detect the additive.

81. The system of claim 80, wherein the additive comprises a fluorescent component, and wherein the image sensor assembly is configured to detect the fluorescent component.

82. The system of claim 80, wherein the additive comprises a reflective component, and wherein the image sensor assembly is configured to detect the reflective component.

83-86. (canceled)

87. The system of claim 80, wherein the concession product comprises:
a concession container holding the concession.

88. The system of claim 87, wherein the additive is coupled to the concession, and wherein the image sensor assembly is configured to detect the additive.

89. The system of claim 87, wherein the additive is coupled to the concession container, and wherein the image sensor assembly is configured to detect the additive.

90-99. (canceled)

100. The system of claim 71, wherein the image sensor assembly is configured to send a signal to the control module when the state of the concession product reaches a predetermined threshold.

101-131. (canceled)

132. A product monitoring system for an event venue, comprising:
a concession product having a state;
a radio frequency sensor assembly operably coupled to the concession product and configured to monitor the state of the concession product; and
a control module configured to receive a signal from the radio frequency sensor, and to send a response.

133-134. (canceled)

135. The system of claim 132, further comprising:
a communication device configured to receive the response from the control module, and to convey the response to a patron within the event venue.

136. The system of claim 132, wherein the concession product further comprises a product container.

137. The system of claim 136, wherein the radio frequency sensor assembly comprises a passive radio frequency antenna attached to the product container.

138. The system of claim 137, wherein the passive radio frequency antenna is configured to short out in response to contact with the concession product.

139. (canceled)

140. The system of claim 137, wherein the passive radio frequency antenna extends along a wall of the product container.

141. The system of claim 140, wherein the system comprises more than one passive radio frequency antenna, and the passive radio frequency antennas are positioned discretely at more than one product level on the product container.

142-144. (canceled)

145. The system of claim 136, wherein the radio frequency sensor assembly comprises an RFID tag attached to the product container, and wherein the RFID tag is coupled to a sensor configured to monitor the state of the concession product.

146-149. (canceled)

150. The system of claim 132, wherein the radio frequency assembly is configured to send a signal to the control module when the state of the concession product reaches a predetermined threshold.

151-226. (canceled)
